(19) United States
(12) Patent Application Publication
(10) Pub. No.: US 2012/0013648 A1
(43) Pub. Date: Jan. 19, 2012

(54) PLANAR ILLUMINATION DEVICE AND IMAGE DISPLAY APPARATUS

(75) Inventor: Hiroshi Yamaguchi, Osaka (JP)

(73) Assignee: PANASONIC CORPORATION, Kadoma-shi, Osaka (JP)

(21) Appl. No.: 13/056,550

(22) PCT Filed: Dec. 1, 2009
(86) PCT No.: PCT/JP2009/006497

§ 371 Date: Jan. 28, 2011

(51) Int. Cl. G09G 5/10; H05B 37/02; F21V 7/22

(52) U.S. Cl. 345/690; 362/613; 315/313

(57) ABSTRACT

A planar illumination device (10) is provided with: a light guide plate (1) having a first surface (1a) and a second surface (1b); a plurality of light sources (2); and a brightness controller. A plurality of prismatic structures (11) are arrayed on the first surface (1a). The light sources (2) are arranged in the same direction as the array direction of the prismatic structures so as to radiate light toward an edge surface (1c) of the light guide plate (1). The brightness controller varies brightness distribution on a light emitting surface of the light guide plate (1) in the array direction of the prismatic structures (11) by controlling light emission of the light sources (2).

### TECHNICAL FIELD

The present invention relates to a planar illumination device and an image display apparatus using the planar illumination device.

### BACKGROUND ART

Thin and lightweight liquid crystal display apparatuses capable of displaying images are known as an image display apparatus. Such liquid crystal display apparatuses have spread rapidly due to the development of image enhancement technology and the price reduction resulting from the progress of production technology. They are now widely used for a monitor of personal computers, a TV receiver, etc.

Transmissive liquid crystal display apparatuses are used commonly as a liquid crystal display apparatus. Such a transmissive liquid crystal display apparatus is provided with a planar illumination device called a backlight device, and forms images by allowing illumination light from the planar illumination device to be spatially modulated through a liquid crystal panel.

One of the problems in the performance of the liquid crystal display apparatus is blur, so-called motion blur, that appears when moving images are displayed. This occurs because the liquid crystal panel holds images within one field.

In order to reduce such motion blur, it is proposed to blink the backlight device in synchronization with the timing of rewriting pixels of the liquid crystal panel (see Patent Literature 1). Use of such a technique can reduce motion blur significantly.

The blinking of the backlight device as mentioned above can be achieved by disposing a plurality of straight fluorescent tubes immediately below the liquid crystal panel so that the horizontal direction is the longitudinal direction thereof and sequentially switching on them in synchronization with image signals.

Further, there is proposed a liquid crystal display apparatus in which strip-shaped light guide plates are disposed on the back side of a liquid crystal panel so that they are aligned in the short direction thereof and one light source for each light guide plate is disposed on at least one edge surface thereof in the longitudinal direction (see Patent Literature 2). In this liquid crystal display apparatus, it is possible to illuminate the liquid crystal panel for each band-shaped region that corresponds to the light guide plate. Therefore, by sequentially switching on the light sources, the same effect as that obtained by selectively switching on a plurality of fluorescent tubes can be obtained.

### CITATION LIST

### Patent Literature

Patent Literature 1: JP 1(1989)-082019 A

Patent Literature 2: JP 2001-92370 A

### SUMMARY OF INVENTION

### Technical Problem

However, the configuration in which a plurality of fluorescent tubes are disposed immediately below the liquid crystal panel requires the liquid crystal panel to be spaced from the fluorescent tubes to some extent in order to irradiate the liquid crystal panel uniformly with the light from the fluorescent tubes that are discretely disposed. Accordingly, the reduction of the thickness of the liquid crystal display apparatus is limited.

On the other hand, the type that employs a plurality of strip-shaped light guide plates has an edge light structure, which enables a better reduction in the thickness as compared to the direct type. However, the number of parts increases, and a special mechanism is required to hold the plurality of light guide plates.

In practice, the glass substrate of a liquid crystal panel is required to be extremely thin in order to achieve an extreme thickness reduction and weight reduction for the liquid crystal apparatus, and maintains the necessary strength by integration with the backlight device. Further, the current situation is that components other than the light guide plate among the components of the backlight device, such as the diffuse sheet and the prism sheet, are thin, and thus the light guide plate functions also as a strength member for maintaining the strength. Therefore, in the case where the strip-shaped light guide plates are aligned in the short direction, a new strength member is required to be provided additionally, which is one of the causes that prevent the thickness reduction and the weight reduction.

In view of the above-mentioned problems, it is an object of the present invention to provide an illumination device that enables each band-shaped region to be illuminated, in the edge light type that uses one light guide plate, and to provide an image display apparatus using the illumination device.

### Solution to Problem

In order to solve the above-mentioned problems, the planar illumination device of the present invention includes: a light guide plate having a first surface that has a plurality of prismatic structures arrayed in parallel to each other and a flat second surface that faces opposite to the first surface, in which the first surface or the second surface forms a light emitting surface; a plurality of light sources arranged in the same direction as the array direction of the prismatic structures so as to radiate light toward an edge surface in parallel to the array direction of the prismatic structures in the light guide plate; and a brightness controller that varies the brightness distribution on the light emitting surface in the array direction of the prismatic structures by controlling the light emission of the plurality of light sources.

Further, the image display apparatus of the present invention includes: at least one above-mentioned planar illumination device; and an image display panel disposed on the side of the light emitting surface of the planar illumination device. The brightness controller of the planar illumination device selectively switches on the plurality of light sources in synchronization with image signals for images to be displayed on the image display panel.

Further, according to another aspect of the present invention, the image display apparatus includes: at least one above-mentioned planar illumination device; and an image display panel disposed on the side of the light emitting surface of the planar illumination device. The brightness controller of the planar illumination device changes the light emission intensity of at least one light source selected from the plurality of light sources, corresponding to information on the brightness of display images in a region that can be illuminated with each of the plurality of light sources in the image display panel.

### Advantageous Effects of Invention

According to the planar illumination device of the present invention, it is possible to emit the light from the light sources through the light emitting surface, with the light guided linearly by the prismatic structures. Therefore, it is possible to illuminate an object to be illuminated, such as an image display panel, for each band-shaped region with a simple and easy configuration using one light guide plate. Further, according to the image display apparatus of the present invention, a high-quality image display with excellent moving image display performance can be achieved by controlling the emission of the light sources at a specific timing using this illumination device.

### BRIEF DESCRIPTION OF DRAWINGS

FIG. 1 is a perspective view showing a configuration of a planar illumination device according to Embodiment 1 of the present invention.

FIG. 2 is a plan view showing the configuration of the planar illumination device according to Embodiment 1 of the present invention.

FIG. 3 is a sectional view showing the function of prismatic structures in the planar illumination device according to Embodiment 1 of the present invention.

FIG. 4 is a block diagram showing a configuration of an image display apparatus according to Embodiment 2 of the present invention.

FIG. 5 is a top view illustrating an illumination state where a common flat light guide plate is used and one light source is individually switched on.

### DESCRIPTION OF EMBODIMENTS

Hereinafter, the embodiments of the present invention are described with reference to the drawings.

### Embodiment 1

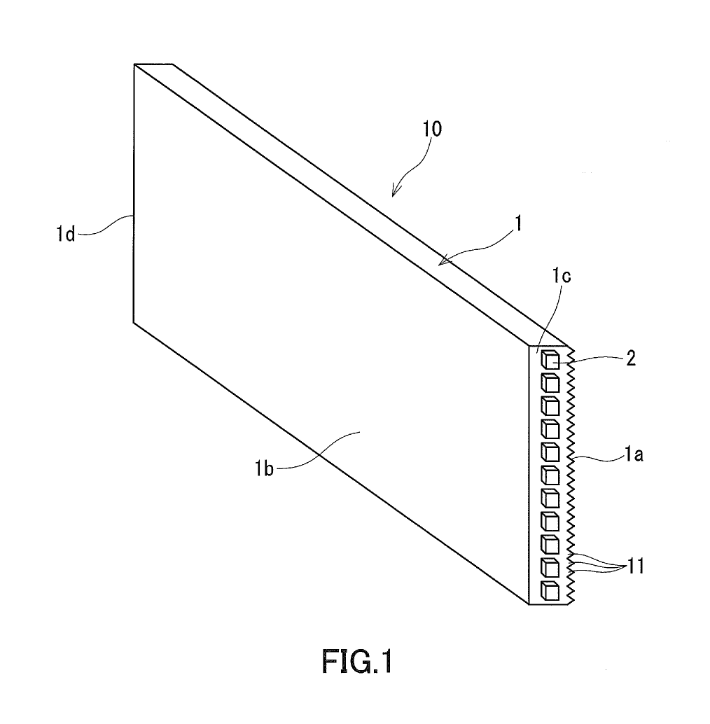

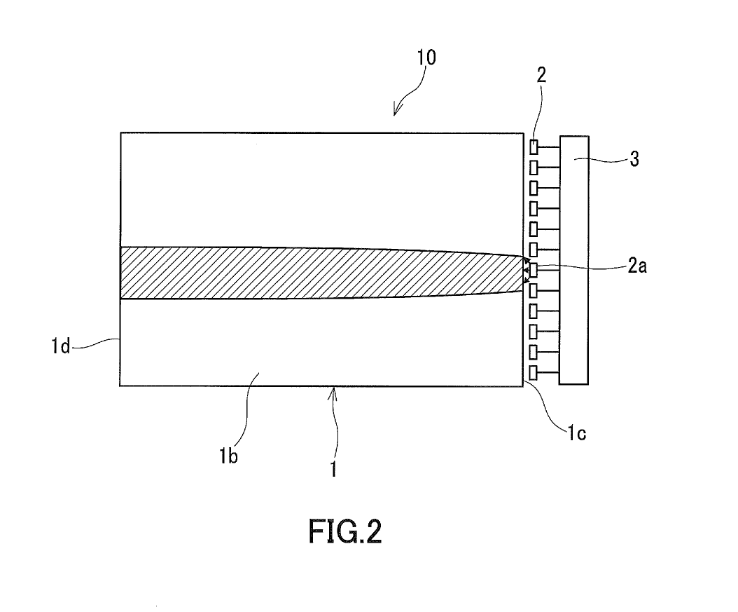

FIG. 1 and FIG. 2 show a planar illumination device 10 according to Embodiment 1 of the present invention. This planar illumination device 10 is provided with a light guide plate 1, a plurality of light sources 2 that are disposed beside the light guide plate 1, and a brightness controller 3 connected to the light sources 2.

The light guide plate 1 has a shape of a substantially elongated rectangular plate. One main surface of the light guide plate 1 forms a first surface 1a, and the other main surface that faces opposite to the first surface 1a forms a second surface 1b. On the first surface 1a, a plurality of prismatic structures 11 are formed so as to be arrayed in parallel and in series to each other. In this embodiment, the array direction of the prismatic structures 11 is the short direction of the light guide plate 1, and the prismatic structures 11 extend in the longitudinal direction of the light guide plate 1. In other words, the longitudinal direction of the light guide plate 1 is orthogonal to the array direction of the prismatic structures 11. However, the array direction of the prismatic structures 11 may be the longitudinal direction of the light guide plate 1. The second surface 1b is a flat surface. It should be noted that the second surface 1b is not necessarily a completely flat surface (mirror surface), and may be a substantially flat surface.

The light guide plate 1 guides light radiated by the light sources 2 so as to be emitted through a light emitting surface. This light emitting surface can be formed of the first surface 1a, or can be formed of the second surface 1b. In this embodiment, the first surface 1a serves as the light emitting surface with the later mentioned configuration.

The light sources 2 are arranged on one side in the longitudinal direction of the light guide plate 1, in the same direction as the array direction of the prismatic structures 11. In this embodiment, LEDs are employed as the light sources 2. The light sources 2 radiate light onto one edge surface (an edge surface in parallel to the array direction of the prismatic structures 11) 1c in the longitudinal direction of the light guide plate 1. That is, the edge surface 1c of the light guide plate 1 serves as an incident surface through which the light from the light sources 2 enters the light guide plate.

The brightness controller 3, for example, is constituted by a circuit board formed with an integrated circuit for driving the light sources 2. The brightness controller 3 controls the brightness distribution on the first surface 1a (light emitting surface) of the light guide plate 1 in the array direction of the prismatic structures 11 by controlling the light emission of the light sources 2. In this embodiment, the brightness controller 3 selectively switches on the light sources 2. However, the brightness controller of the present invention is not limited thereto, and may be, for example, one that changes the light emission intensity of at least one light source selected from the light sources 2.

Next, the operation of this embodiment is described.

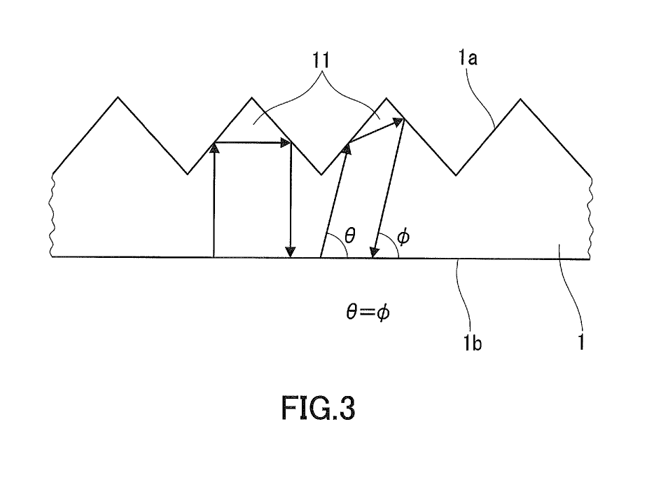

FIG. 2 is a plan view illustrating an illumination state where only one light source 2a among the plurality of light sources 2 is switched on by the brightness controller 3. The light that has entered the light guide plate 1 through the edge surface 1c travels toward the other edge surface 1d (in the left direction in FIG. 2) inside the light guide plate 1 almost without diffusing in the array direction of the prismatic structures 11 (in upward and downward directions in FIG. 2), due to the function of the prismatic structures 11 provided on the first surface 1a. The mechanism thereof is described with reference to FIG. 3.

FIG. 3 is an enlarged sectional view showing a part of the light guide plate 1. Typical trajectories of the light rays that travel inside the light guide plate 1 are shown by arrows in FIG. 3.

The apex angle of each of the prismatic structures 11 is set to about 90 degrees. Therefore, in the cross section, the light incident on one prism surface of the prismatic structure 11 at an angle θ with respect to the second surface 1b is reflected totally by this surface, then is incident on the other opposed prism surface and further reflected totally by the other surface, and eventually is incident on the second surface 1b at an angle φ. Since the apex angle of the prismatic structure 11 is set to 90 degrees, φ is equal to θ.

Although the reflection angles are shown in FIG. 3 as if the light were not reflected totally by each prism surface, this is because they are shown by trajectories as projected on the cross section. The light travelling inside the light guide plate 1 actually has an angle in the depth direction of this view, and all the light that has been reflected totally by the second surface 1b satisfies total reflection conditions also on the prism surfaces. As a result, the light rays travel in the depth direction of the view almost without diffusing in the left and right directions of the view.

In the case where all of the second surface lb and the prism surfaces are formed as a mirror surface, the light rays exit through the other edge surface 1d that faces the edge surface 1c as the incident surface, while repeating total reflection. In order to achieve planar illumination, for example, a white reflecting surface in a dot pattern or fine concavo-convex structures are formed on the second surface 1b to cause the light rays to be deviated from the total reflection conditions, so that the deviated light rays are emitted through the first surface 1a (light emitting surface). By adjusting the shape or density of this white reflecting surface in a dot pattern or fine concavo-convex structures, it is possible to emit light substantially uniformly in the area from the edge portion on the light incident side of the light guide plate 1 to the edge portion on the opposite side thereof. Alternatively, the second surface 1b can be made as the light emitting surface by forming a white reflecting surface in a dot pattern or fine concavo-convex structures on the prism surfaces while the second surface 1b being a mirror surface.

The brightness controller 3 selects a specific light source from the light sources 2, and switches on the selected light source. Thus, light is emitted through the light emitting surface by the linear area that corresponds to each of the selected light sources. That is, the control of the light emission of the light sources 2 by the brightness controller 3 enables the brightness of the light emitting surface to be determined for each of the linear areas that are aligned in the array direction of the prismatic structures 11 and that correspond to the respective light sources 2. When selectively switching on the light sources 2, the brightness controller 3 may switch on only one of the light sources 2, or may switch on a selected group of the light sources 2 into which the light sources 2 have been divided.

As described above, the illumination device 10 of this embodiment allows the light from the light sources 2 to be emitted through the light emitting surface, with the light being guided linearly by the prismatic structures 11. Therefore, it is possible to illuminate an object to be illuminated, such as an image display panel, for each band-shaped region with a simple and easy configuration using the single light guide plate 1.

The band-shaped region to be illuminated can be determined by the width of the light rays to be incident into the edge surface 1c of the light guide plate 1. This can be specified by the light distribution properties of the light sources 2 that are LEDs and the distance from the light sources 2 to the edge surface 1c.

According to the above-mentioned configuration, the brightness controller 3 selectively switches on the light sources 2 and thus a part of an object to be illuminated can be illuminated selectively. This enables a desired portion to be highlighted at a desired timing, for example, on a display in the station yard. Further, an improvement in moving image display performance can be achieved by using the planar illumination device 10 of this embodiment as a backlight device in a liquid crystal display apparatus, as described later, and blinking it in synchronization with image signals.

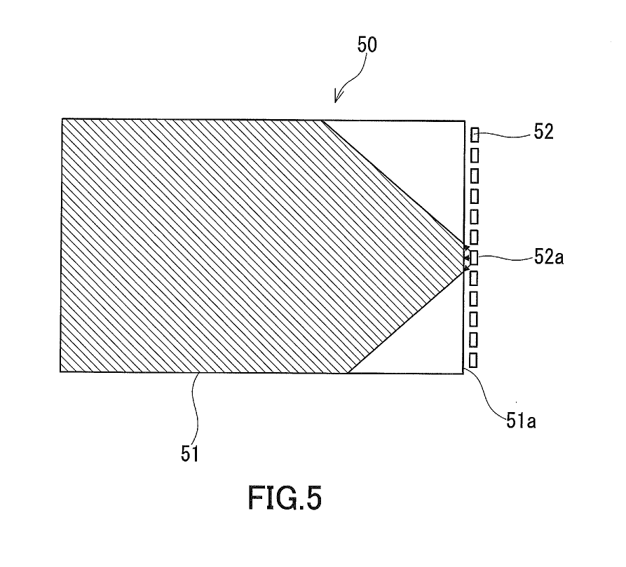

For reference, FIG. 5 illustrates an illumination state where a light guide plate 51 with both main surfaces formed as a flat plate is used and one LED 52a among a plurality of LEDs 52 is switched on. In a planar illumination device 50 shown in FIG. 5, both main surfaces of the light guide plate 51 are flat. The LEDs 52 are arranged facing an edge surface 51a in the longitudinal direction of the light guide plate 51. As shown in this view, the region that can be illuminated with the single LED 52a spreads into a fan shape from the edge surface 51a that is the incident surface. Even in the case of using a light guide plate having prismatic structures, when light enters the light guide plate through an edge surface thereof perpendicular to the array direction of the prismatic structures (in parallel to the extending direction of the prismatic structures), the region to be illuminated has a fan shape in the same manner.

In this embodiment, an LED is employed as the light source 2. However, the light source 2 is not limited to this. For example, the light source 2 may be an inorganic or organic EL device. Alternatively, a plurality of short fluorescent tubes may be arranged as the light sources 2, and they may be selectively switched on.

Further, although the light sources 2 are disposed on one side in the longitudinal direction of the light guide plate 1 in this embodiment, the light sources 2 may be disposed on both sides in the longitudinal direction of the light guide plate 1. In this case, a white reflecting surface in a dot pattern or fine concavo-convex structures to be formed on the first surface 1a or the second surface 1b of the light guide plate 1 may be disposed so as to become more closely concentrated from both edges toward the center of the light guide plate 1 so that the light from the light sources 2 should be substantially zero around the center of the light guide plate 1. In this way, the band-shaped region to be illuminated can be further divided into two in the longitudinal direction.

It should be noted that prismatic structures conventionally are provided in a planar illumination device to be used as a backlight device in a liquid crystal display apparatus. The object thereof is to control the light distribution properties of the light emitted through the main surface and increase the illumination intensity in the front direction. It is common to provide a prism sheet on the side of the light emitting surface of a light guide plate whose both surfaces are flat. There is also an example of providing prisms on a light guide plate, but this is intended to omit a prism sheet in order to simplify the structure. The object and function of controlling the light distribution properties in the normal direction to the surface are the same as in the case of providing a prism sheet.

The planar illumination device of the present invention uses the trapping effect of the light travelling inside the light guide plate caused by prismatic structures, and the object thereof is different from that in conventional configurations. The object of the present invention can be achieved by controlling the light emission of a plurality of light sources using a brightness controller, which enables illumination for each band-shaped region. The conventional configurations using prismatic structures have no idea of controlling the light emission of a plurality of light sources individually.

### Embodiment 2

Next, an image display apparatus according to Embodiment 2 of the present invention is described. The image display apparatus of this embodiment is a liquid crystal display apparatus having a liquid crystal panel as an image display panel. The liquid crystal display apparatus according to Embodiment 2 uses the planar illumination device described in Embodiment 1 as a backlight device, and selectively causes a corresponding portion to blink in synchronization with image signals. This allows motion blur to be reduced, and enables the moving images display quality to be improved. The array direction of prismatic structures may be the vertical direction or the horizontal direction.

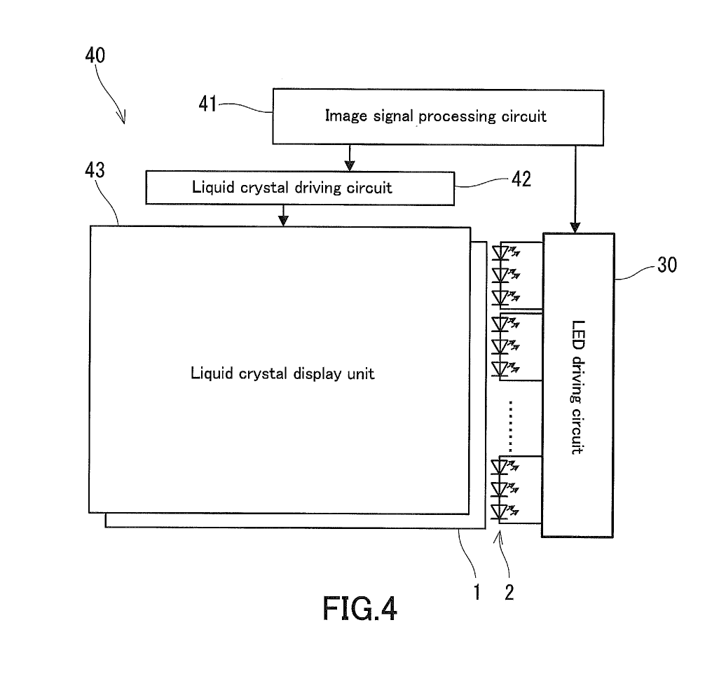

FIG. 4 is a block diagram showing a main configuration of a liquid crystal display apparatus 40 according to Embodiment 2. This liquid crystal display apparatus 40 is provided with the planar illumination device including the light guide plate 1, and the liquid crystal panel disposed on the side of the light emitting surface of the planar illumination device. The liquid crystal panel is a component of a liquid crystal display unit 43. Furthermore, the liquid crystal display apparatus 40 is provided with an image signal processing circuit 41, a liquid crystal driving circuit 41, and an LED driving circuit 30. The LED driving circuit 30 functions as the brightness controller of the planar illumination device described in Embodiment 1.

The image signal processing circuit 41 transmits image signals for the images to be displayed on the liquid crystal panel, to the liquid crystal driving circuit 41 and the LED driving circuit 30. The liquid crystal driving circuit 42 controls the liquid crystal panel of the liquid crystal display unit 43 corresponding to the image signals from the image signal processing circuit 41.

The LED driving circuit 30 selectively switches on the light sources 2 in synchronization with the image signals from the image signal processing circuit 41 so that light should be emitted by the light source 2 that is an LED for a specific portion, corresponding to the image signals from the image signal processing circuit 41. Specifically, the LED driving circuit 30 selectively keeps the light sources 2 on for a certain period of time so that the region corresponding to the image signals should be illuminated in synchronization with a perpendicular scan of one frame in the image signals. With such a configuration, only a specific portion is illuminated appropriately with blinking light using the single light guide plate 1, which can reduce motion blur and improve the moving image display performance.

Further, different from the case of using a plurality of conventional strip-shaped light guide plates, the light guide plate 1 is formed as one body and therefore functions sufficiently as a strength member for maintaining the strength, in this embodiment. Thus, there is no need to add a new strength member.

As described above, according to the configuration of this embodiment, the moving image performance of a liquid crystal display apparatus can be improved with a simple and easy configuration without using a plurality of light guide plates, and thus a thin and lightweight liquid crystal display apparatus with high display quality can be achieved.

In this embodiment, the LED driving circuit 30 selectively switches on the light sources 2 in synchronization with the image signals from the image signal processing circuit 41. However, the LED driving circuit 30 may change the light emission intensity of at least one light source selected from the light sources 2, corresponding to information on the brightness of display images in the region that can be illuminated with each light source 2 in the liquid crystal panel. For example, the light emission intensity may be controlled to be higher for the light source that corresponds to the bright portion of the display image, and to be lower for the light source that corresponds to the dark portion of the display image. Such control enables the consumption power to be reduced, as well as allowing the contrast between bright and dark in the display image to be further enhanced and the image quality to be improved. It should be noted that the LED driving circuit 30 may combine selective switching of the light sources 2 with controlling of the light emission intensity of the selected light source 2.

Furthermore, the image display apparatus of the present invention is not limited to the configuration provided with one planar illumination device, and may be provided with a plurality of planar illumination devices.

Moreover, it is needless to say that the modified example described in Embodiment 1 is applicable also to the planar illumination device to be used for the image display apparatus. For example, the light sources 2 may be disposed on both sides of the light guide plate 1 in the direction orthogonal to the array direction of the prismatic structures.

### INDUSTRIAL APPLICABILITY

According to the present invention, image display with less motion blur can be achieved using a less number of parts and a simple structure. Thus, the present invention is particularly useful for reducing the thickness and weight of image display apparatuses that require high-quality images, such as a liquid crystal television and a liquid crystal monitor, and for improving the display performance thereof.

1. A planar illumination device comprising:
a light guide plate having a first surface that has a plurality of prismatic structures arrayed in parallel to each other and a flat second surface that faces opposite to the first surface, the first surface or the second surface forming a light emitting surface;
a plurality of light sources arranged in the same direction as the array direction of the prismatic structures so as to radiate light toward an edge surface of the light guide plate in parallel to the array direction of the prismatic structures; and
a brightness controller that varies brightness distribution on the light emitting surface in the array direction of the prismatic structures by controlling light emission of the plurality of light sources.

2. The planar illumination device according to claim 1, wherein the brightness controller selectively switches on the plurality of light sources.

3. The planar illumination device according to claim 1, wherein
the brightness controller changes light emission intensity of at least one light source selected from the plurality of light sources.

4. The planar illumination device according to claim 1, wherein
the plurality of light sources are disposed on both sides of the light guide plate in a direction orthogonal to the array direction of the prismatic structures.

5. An image display apparatus comprising:
at least one said planar illumination device of claim 1; and
an image display panel disposed on the side of the light emitting surface of the planar illumination device, wherein
the brightness controller of the planar illumination device selectively switches on the plurality of light sources in synchronization with image signals for images to be displayed on the image display panel.

6. The image display apparatus according to claim 5, wherein
the array direction of the prismatic structures is the vertical direction.

7. The image display apparatus according to claim 5, wherein
the array direction of the prismatic structures is the horizontal direction.

8. An image display apparatus comprising:
at least one said planar illumination device of claim 1; and
an image display panel disposed on the side of the light emitting surface of the planar illumination device, wherein
the brightness controller of the planar illumination device changes light emission intensity of at least one light source selected from the plurality of light sources, corresponding to information on brightness of display images in a region that can be illuminated with each of the plurality of light sources in the image display panel.

9. The image display apparatus according to claim 8, wherein
the array direction of the prismatic structures is the vertical direction.

10. The image display apparatus according to claim 8, wherein
the array direction of the prismatic structures is the horizontal direction.
